(19) United States
(12) Patent Application Publication
(10) Pub. No.: US 2011/0196888 A1
(43) Pub. Date: Aug. 11, 2011

(54) Correlating Digital Media with Complementary Content

(75) Inventors: Eric Hanson, Emeryville, CA (US); Joshua David Fagans, Redwood City, CA (US)

(73) Assignee: APPLE INC., Cupertino, CA (US)

(21) Appl. No.: 12/703,620

(22) Filed: Feb. 10, 2010

(51) Int. Cl. G06F 17/30

(52) U.S. Cl. 707/769; 707/E17.014; 707/E17.019; 707/802; 707/758

(57) ABSTRACT

Methods, apparatuses, and systems for correlating digital media with complementary content. Multiple digital images, that are associated with image information including either a time of capture or a geographic location of capture, and additional information describing events that occurred either during these times or geographic locations of capture are received. The image information and the additional information are compared to identify related events and images, which are associated with each other. Upon detecting input to provide the multiple digital images for presenting, the additional information describing the identified events are provided with the identified digital images.

### TECHNICAL FIELD

This specification relates to managing digital media, for example, by correlating items of digital media with complementary content obtained from one or more sources.

### BACKGROUND

Digital media include digital representations of content, such as, images, music, video, documents, and the like. Such media can be stored in electronic format, for example, JPEG, AVI, PDF, and the like, and transferred electronically, for example, from one data storage device to another, through electronic mail, and the like. The media can be created in one of several ways. For example, digital video images are captured using digital recorders and cameras, digital documents are created by several techniques including using suitable computer software applications, scanning hard-copies of documents, and the like, and digital music is created using audio recorders. Managing a digital media item generally describes performing one or more operations on the media items including creating, storing, transferring, editing, presenting, and the like.

In some scenarios, presenting a digital media item includes creating a composite presentation using other media items. For example, a digital still image slide show represents a composite media item that is created from the individual digital images in the slide show. Often, the digital media items presented in such a slide show share a common factor, in that each of the individual digital media items were selected by the same user for inclusion in the slide show.

### SUMMARY

This specification describes technologies relating to automatically correlating digital media with complementary content.

In general, an aspect of the subject matter described in this specification can be implemented as a method for presenting digital media content. The method includes receiving, by data processing apparatus, multiple digital images. A digital image is associated with image information that includes either a time of capture of the digital image or a geographic location of capture of the digital image or both. The method includes receiving, by the data processing apparatus, additional information describing events that occurred either during times of capture or at or substantially near geographic locations of capture of one or more of the multiple digital images. The method includes comparing, by the data processing apparatus, the image information and the additional information to identify one or more events and one or more digital images that are related. The method includes associating, by the data processing apparatus, the identified one or more events and the identified one or more digital images. The method includes detecting, by the data processing apparatus, input to provide the multiple digital images for presenting. The method includes providing, by the data processing apparatus, the additional information describing the identified one or more events for presenting with the identified one or more digital images.

This, and other aspects, can include one or more of the following features. The additional information describing events can be obtained by monitoring the events for a duration of time, and collecting the additional information at particular instances during the duration. The additional information describing events can further be obtained by monitoring geographic locations at which the events occurred during the duration, and collecting geographic location information at the geographic locations at which the events occurred during the duration. The geographic locations information includes, for a geographic location, a time at which the events occurred at the geographic location. Comparing the image information and the additional information can include storing multiple events scheduled to occur at future times in a database, and comparing a time of capture of a digital image with times of occurrences of the multiple events to identify the one or more events. Associating an event with the multiple digital images based on the comparing can include determining that a time of occurrence of the event was substantially near a time of capture of a digital image in the multiple digital images. Geographic information, included in the image information, can describe the geographic location of capture. The method can further include receiving a digital image associated with geographic information, searching a database of geographic locations to identify the geographic location described by the geographic location, and associating the geographic location with the digital image. The additional information can include ambient temperatures at a geographic location obtained by monitoring weather at the geographic location for a duration. The method can further include determining, based on the comparing, that a digital image of the multiple digital images is captured at the geographic location at which the weather is monitored, associating the ambient temperature collected at the time of capture of the digital image with the multiple digital images, and upon detecting an input to provide the multiple digital images, automatically providing the collected ambient temperature with the multiple digital images. The image information can include metadata associated with each digital image. The method can further include associating the metadata with each digital image subsequent to the time of capture. Capturing the multiple digital images, the receiving of the image information, and the receiving of the additional information can be performed by a mobile communication device further configured to perform the comparing, the associating, the detecting, and the providing.

Another aspect of the subject matter described in this specification can be implemented in a computer-readable medium, tangibly encoding software instructions, executable by data processing apparatus to perform operations. The operations include receiving multiple digital images associated with image information describing times of capture of the multiple digital images. The operations include receiving a first set of multiple geographic locations identified by geographic location information that includes times at which the first set of geographic locations are identified. The operations include receiving additional information describing events that occurred over a duration of time and at a second set of multiple geographic locations. The additional information is received after receiving the multiple digital images and the multiple geographic locations. The operations include correlating one or more events with one or more of the digital images based on determining that one or more of the digital images were captured during the duration that one or more events occurred or substantially near one or more of the second set of multiple geographic locations at which the one or more events occurred. The operations include associating the one or more digital images that are correlated with the one or more events with names of the one or more correlated event such that in response to a search query that includes a name of one of the correlated events, the one or more digital images are provided as search results.

This, and other aspects, can include one or more of the following features. The operations can further include receiving the search query that includes a name of one of the correlated events, and in response to the receiving, providing the grouped one or more digital images. Providing the grouped one or more digital images can include presenting the grouped one or more digital images, and presenting, with the presented digital images, digital content representing the one or more correlated events with which the presented digital images are correlated. Receiving the additional information describing the events can further include receiving the additional information from one or more external devices configured to monitor the events, to periodically record times of occurrences of the events, and to record the geographic locations in which the events occur. The multiple digital images can be received from a mobile communication device configured to capture digital images. The image information can be represented by metadata associated with each of the digital images, and can include a time of capture of a digital image. The geographic location information can be received from the mobile communication device configured to track Global Positioning System (GPS) coordinates at which the mobile communication device is located. The additional information can be received from a calendar software application executing on the mobile communication device. The calendar software application can store multiple appointments, each representing an event spanning a duration of time. A digital image can be correlated with an appointment upon determining that the time of capture of the digital image is within the duration of the appointment. The digital image can be associated with text included in the appointment. The text can identify the appointment.

In another aspect, the subject matter described in this specification can be implemented as an apparatus that includes an input element, an output element, and processing circuitry operatively coupled to the input element and the output element to perform operations. The operations include receiving multiple digital images. A digital image is associated with image information that includes either a time of capture of the digital image or a geographic location of capture of the digital image or both. The operations include receiving additional information describing events that occurred either during times of capture or at or substantially near geographic locations of capture of one or more of the multiple digital images. The operations include comparing the image information and the additional information to identify one or more events and one or more digital images that are related. The operations include associating the identified one or more events and the identified one or more digital images. The operations include detecting input to provide the multiple digital images for presenting, and providing the additional information describing the identified one or more events for presenting with the identified one or more digital images.

This, and other aspects, can include one or more of the following features. The operations can further include capturing the multiple digital images, and associating a time of capture with each of the captured digital images. The operations can further include tracking geographic locations at which the input element and the output element are located. The tracking can include periodically recording times at which the input element and the output element are at the geographic locations. The additional information describing the events can be received from an external device configured to monitor the events and to associate the additional information with the events based on the monitoring. The input element can be configured to receive digital content. The output element can be configured to present the received digital content. The processing circuitry can be configured to include in the additional information, a time at which the received digital content is provided. The operations can further include comparing times of capture of digital images and the time at which the digital content is provided, correlating one or more digital images with the provided digital content upon determining that the time at which the digital content was provided was within a threshold of the time at which the one or more digital images were captured, and providing the digital content for presenting with the correlated one or more digital images. The received digital content can be a digital song. The processing circuitry can be configured to play the digital song, to monitor a time at which the digital song is played, and to include the time of playing the digital song in the additional information. Providing the digital content for presenting with the correlated one or more digital images can include including the digital song with the correlated one or more digital images, such that when the correlated one or more digital images are displayed, at least a portion of the digital song is simultaneously played.

In another aspect, the subject matter described in this specification can be implemented as a method that includes accessing, by data processing apparatus, multiple digital images and metadata associated with one or more of the digital images. The method includes identifying, by the data processing apparatus, events associated with complementary digital information. The events are related to the accessed one or more of the digital images. The method includes generating, by the data processing apparatus, an enhanced media presentation including one or more of the digital images, at least a portion of the metadata, and the identified complementary information.

This, and other aspects, can include one or more of the following features. The method can further include correlating the events with the one or more of the digital images by comparing the metadata associated with the one or more of the digital images and the complementary digital information associated with the events. The digital information associated with an event can include a time of occurrence of the event. The metadata associated with a digital image can include a time of capture of the digital image. Correlating the events with the one or more of the digital images can include determining a difference between the time of occurrence of the event and the time of capture of the digital image, and upon determining that the difference is within a threshold, correlating the event and the digital image. Generating the enhanced media presentation can further include detecting input to include the digital image correlated with the event in the enhanced media presentation, automatically including the event in the enhanced media presentation, and presenting the event concurrently with the digital image.

Particular implementations of the subject matter described in this specification can be implemented to realize one or more of the following advantages. Digital images, captured by a user, often have an underlying a context under which the images are captured, for example, a vacation, a social gathering, a visit to a geographic location, and the like. By associating digital images with events that occurred during the time that the images were captured and/or at the location at which the images were captured, correlations between the digital images and the events can be developed. Correlating events monitored by external devices with digital images captured by a user, without receiving input from the user to do so, can improve the user experience. Such correlations can augment the digital media captured by a user with contextual information about the environment in which the user captured the digital images. The contextual information can be obtained from the events. Also, such correlations can be developed automatically, i.e., without requiring that a user identify events that can be correlated with the digital images. This can decrease time spent identifying media for correlating, and can increase the efficiency of a computer systems configured to enable the user to create digital media. Further, the events that can be correlated with the images can include not only user-generated events but also events that are monitored by external devices. Furthermore, such correlations can be developed as the user is capturing digital images or subsequent to digital image capture or both. In addition, if a user who captured the digital image is unaware or has not observed the event that occurred when the image was captured, the additional context correlated with the image can make the user aware of the event, thereby increasing the enjoyment derived from viewing the image.

The details of one or more implementations of the specification are set forth in the accompanying drawings and the description below. Other features, aspects, and advantages will become apparent from the description, the drawings, and the claims.

### BRIEF DESCRIPTION OF THE DRAWINGS

FIG. 1 shows an example system for managing digital media.

FIG. 2 shows an example mobile computing device that exchanges information with multiple external devices.

FIG. 3 shows an example mobile computing device that creates a presentation of correlated digital images and events.

FIG. 4 shows an example computer system that presents correlated digital images and events.

FIG. 5 is a flow chart of an example process for correlating digital images and events.

FIG. 6 is a flow chart of an example process for storing correlated digital images and events under a name.

FIG. 7 is a flow chart of an example process for generating an enhanced media presentation.

Like reference numbers and designations in the various drawings indicate like elements.

### DETAILED DESCRIPTION

Digital media items can be of different types and can be obtained using different devices, each configured to obtain an item of a particular type, or using a single device configured to obtain multiple items of multiple types. In some scenarios, the item can be obtained using a mobile communication device, for example, personal digital assistant, a mobile device configured to capture images, play audio/video, and the like. In some scenarios, each item can be obtained using a corresponding device, and all such obtained media can be transferred to a single computer system using which the media can be managed, for example, edited for displaying.

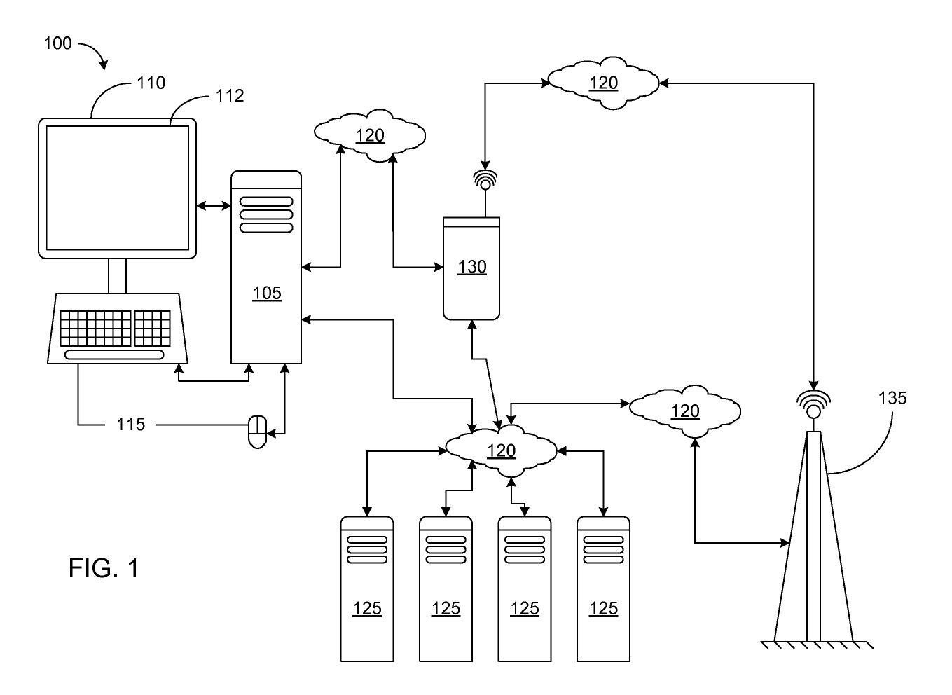

Using techniques described later, image information that is associated with digital images is used to correlate one or more images with events determined to be related to the correlated images based on comparing the image information with complementary digital information associated with the events. The correlations can be created by a system described with reference to FIG. 1. Complementary digital information can be any type of information associated with a digital media item, for example, data captured by the media item, metadata associated with the item by the device with which the media item is captured, data and metadata associated with the item by a user, and the like.

FIG. 1 shows an example system 100 for managing digital media. The system 100 includes a computer system 105, for example, a desktop computer, a laptop computer, and the like, that is operatively coupled to a display device 110, for example, a liquid crystal display (LCD) monitor. The computer system 105 is configured to execute computer software instructions, the outputs of which can be displayed in the display device 110, for example, in a user interface 112. A mobile computing device 130 is coupled to the computer system 105 through the network 120. The mobile computing device 130 includes processing circuitry that is configured to execute computer software instructions, the outputs of which can be displayed in the device 110. The following techniques, that describe correlating digital images with events, can be implemented using either the computer system 105 or the mobile computing device 130 or both. Techniques using which the device 130 can receive the digital images are described below.

The mobile computing device 130 can receive digital media items from a user of the device 130. For example, in situations in which the device 130 is configured to capture digital media items, the device 130 receives digital images that the user captures using the device 130. In some situations, the user can capture digital images using a digital camera, and upload the captured images to a data storage device, for example, a hard disk of the computer system 105, a universal serial bus (USB) memory device, and the like. Subsequently, the user can transfer the captured digital images to the device 130 from one or more of the digital camera, the hard disk of the computer system 105, and the USB memory device. In this manner, the device 130 can receive digital images as data files from storage devices in response to the user's actions to transfer the images to the device 130. Alternatively, or in addition, digital images can be transferred to the device 130 through electronic mail (e-mail) or data networks, for example, the Internet. Digital images can also be transferred to the device 130 via a “peer to peer” connection with another device, for example, Bluetooth. Also, the device 130 can be configured to receive digital images via feeds.

All digital images are associated with image information that describe the image. Image information includes image metadata that describes an image, for example, a time of capture, a geographic location of capture, a description associated with the image by a user, and the like. Image information also includes the pixel information representing the captured image. In some situations, the device 130 is configured to additionally identify the image information that includes a time of capture of the digital image and associate the time of capture with the digital image. In some implementations, the captured image is stored as a data file that includes pixel information and the time of capture, for example, a date and time, is stored as image metadata in the data file. The metadata also includes a data file name under which the digital image is stored, file properties such as file size, file type, properties of the device using which the image was captured, for example, camera focal length, aperture settings, and the like. Thus, each image received by the mobile computing device 130 is associated with a corresponding time of capture.

In some implementations, each digital image can also be associated with image information representing a corresponding geographic location of capture. For example, latitude/longitude/altitude information included in Global Positioning System (GPS) coordinates can be associated as metadata with each digital image data file to represent a location at which the image was captured. In some scenarios, the device used to capture the image can also be configured to record the geographic location, for example, the GPS coordinates.

In other scenarios, a first device can be used to capture the image and a second device can be used to record the geographic location information. The geographic location information includes a reference time (for example, in Greenwich Mean Time) at which the geographic location information was recorded. If a user captures a digital image and geographic location information at a geographic location, then the location can be associated with the image by determining that the time at which the user recorded the geographic location matches the time at which the user captured the image.

Image information additionally includes text associated with a digital image. The text can be received from a user managing the digital image and can be, for example, a data file name under which the user stores the image, a caption, such as, text, that the user associates with the image, and the like. In addition to receiving digital images, the device 130 can also receive the image information that includes either a time of capture of each digital image or a geographic location of capture of the digital image or both. Further, the image information can include compass information, i.e., directional information representing a direction in which the device 130 was facing when the image was captured. The directional information can be received from a compass, for example, and can provide metadata that can be used for fine-tuning the event correlation. In some implementations, the device 130 can receive the images and the image information as data files with which the image information is associated as metadata. To correlate one or more of the digital images with events, the device 130 receives complementary digital information about the events, as described below.

An event is any occurrence having associated digital information that can be collected, stored, and retrieved. For example, Super Bowl is an event with which digital information, including a time of occurrence, a place of occurrence, participating teams, team information, and the like, can be associated as digital information, stored, for example, in a data server hosting a website, and retrieved. Information associated with an event can provide contextual information about the event. For example, a social gathering is an event that occurs at a specified time and place. If several attendees of the social gathering record any digital media items during the gathering, such as, images, video, audio, and the like, then each recording is included as digital information representing the event.

Alternatively or in addition, a single event can occur over a duration of time or across multiple locations. For example, a vacation is an event that can be represented by recording of digital media items in different geographic locations at different times. In this example, all recorded digital media items represent the event. Events can also be monitored continuously by external devices that periodically capture and record digital information about the event. For example, weather services monitor ambient temperature, for example, by periodically collecting ambient temperatures at instances of time or at geographic locations or both, and associate the temperature, time, and geographic location. In this example, the weather represents an event that is monitored. In this manner, digital information is associated with the events.

The mobile computing device 130 can obtain events and associated digital information from different sources. In some situations, the device 130 receives the media items by monitoring data hosts 125 that store multiple digital media items. To do so, the device 130 is operatively coupled to the data hosts 125 over the networks 120, for example, the Internet, the Wi-Fi network, a cellular telephone network provided by a service provider 135, and the like. The device 130 executes computer software applications that cause information to be exchanged between the device 130 and the data hosts 125. For example, the data hosts 125 are data servers that host websites and store digital media items that are included in the various web pages of the websites.

The data hosts 125 can monitor events over durations of time, for example, by periodically storing digital information associated with the events. Ambient weather is an example of an event that can be monitored by a data host 125. For example, a website that provides ambient temperatures at a geographic location is hosted by a data host 125. Periodic updates about the ambient temperatures at the geographic location are obtained, for example, from a weather monitoring service. The updates include ambient temperatures at particular time instants. By storing the ambient temperatures over a duration as digital information in a data storage, the data host 125 monitors the weather at the geographic location.

In this example, ambient weather is the event and the stored data describing the ambient temperature and the time at which the ambient temperature was obtained are examples of digital information associated with the event. Ambient temperatures for past and present time instances, and temperature predictions for future time instances can be stored in the data host 125. Additionally, ambient temperatures at multiple geographic locations can also be stored in the data host 125. Such a data host 125 and the mobile computing device 130 can exchange data such that, in response to input from the device 130, the data host 125 transmits the digital information that includes ambient temperatures and times at which the ambient temperatures were recorded. The digital information thus obtained from the data hosts 125 can be stored in the device 130. Another example of an event that can be monitored is the performance of the New York Stock Exchange (NYSE), such that stock index values at particular time instances can be stored for a duration, and then transferred to the device 130.

In some implementations, the device 130 receives multiple digital images, each of which is associated with image information that includes a time of capture of the image. The image information also includes geographic location information, for example, GPS coordinates, at which the images were captured. From the image information, the device 130 can identify a time of capture of an image and a geographic location in which the image was captured. As described previously, the device 130 periodically receives digital information from the data host 125 on which ambient weather information is stored. By comparing the digital information received from the data host 125 with the image information of the digital images, the device 130 can identify an ambient temperature at the geographic location at the time of capture of the digital image. In this manner, the device 130 can identify an event that complements an image, and correlate the event and the image. Thus, the device 130 can associate the image with the event, i.e., the ambient temperature at the time and the geographic location of capture of the image.

Alternatively, or in addition, the correlation between the event and the image can be performed by interpolation. For example, ambient temperature may be recorded at half hour intervals. Through either simple linear interpolation or by way of more complex weighted interpolations, a reasonably accurate temperature can be determined within a half hour interval. In this manner, ambient temperatures at times within recording intervals can be correlated with images captured within the intervals.

The device 130 can detect input to provide the images for presenting. In some situations, the device 130 can be synchronized with the computer system 105, and the input can be received from a user of the computer system 105. In some situations, the input can be received from a user of the device 130 to display the images in the display portion of the device 130. In such situations, the device 130 provides the digital information describing the events, i.e., the weather at the geographic location, for presenting with the images. For example, in a composite presentation including a slide show of the digital images, when the device 130 detects that the image with which the ambient temperature has been associated is to be displayed, then the device 130 can automatically present an indication of the ambient temperature.

The indication can be a call-out banner that displays the ambient temperature overlaid over the image. From the digital information that complements the image information, the device 130 can determine that sunshine was prevalent at geographic location at the time that the image was captured, and consequently, display the text “Sunny” or an image of the sun overlaid on the image. If the digital information about the weather indicates snow at the time the image was captured, then the device 130 can display an animation representing falling snow flakes when the image is displayed. Such indications can be provided for all the images being presented. In this manner, the indication displayed by the device 130 provides contextual information describing an environment under which the plurality of images were captured.

For example, components of a printed book theme can be configured to change based on the ambient temperature data correlated with the digital images displayed on each page of the book. For an image correlated with a sub-zero temperature, the art element, such as a frame, that surrounds the digital image can appear icy. For another image correlated with high-temperatures, the art element can appear to be sweating. Other appearances to art elements, specifically those relevant to the information correlated with the images, are also possible.

In another example, a sports event can be correlated with digital images. The device 130 can obtain digital information describing selected sports events that are regularly monitored by known websites hosted by data hosts 125. For example, the data host 125 can store schedules of games to be played by teams in a major sport, for example, the National Football League, Major League Baseball, the National Basketball Association, and the like. The data host 125 can store time and geographic location information describing times and locations at which the games will be played. The occurrence of a game at the time and the location is an event that can be recorded by the data hosts 125. Because the schedules are subject to change over the course of the season, the data hosts 125 periodically monitor the schedules, and provide updated time and geographic location information about the schedules to the device 130.

In this example, the device 130 receives multiple digital images, and, based on the image information, determines times and geographic locations of capture of the images. The device 130 compares the image information and the digital information representing a time and place of occurrence of a sports event. Based on the comparing, the device 130 determines that one or more of the digital images were captured at the geographic location at which the sports event occurred. In response to receiving input to present the multiple digital images, for example, in a slide show, the device 130 includes, for presenting in the slide show, information describing the sports event. For example, when the digital image that was captured at the sports event is to be displayed, a caption indicating the teams that participated in the sports event is overlaid on the digital image. Alternatively, or in addition, a the color theme of a digital book in which the images are displayed can be automatically altered to reflect the colors of the competing teams, i.e., with no user interaction.

In some implementations, the device 130 includes a data storage in which the device 130 stores the events and the complementary digital information. To do so, the device 130 transmits requests to multiple data hosts 125 known to store events of interest, and receives the digital information in response to the requests. In some implementations, the data storage is configured store the digital information in computer-searchable data tables. For example, each event can be an entry in a row in the data table, the row including columns that each include a title of the event, a time of occurrence of the event, a geographic location at which the event occurs, and the like. When the device 130 receives a digital image and image information, the device 130 searches the data table to determine if the time of capture of the image matches a time of occurrence of an event. If a match is detected, then the device 130 correlates the event with the digital image. Additionally, the device 130 can correlate by interpolating, as described previously.

An event and an image can be correlated even if the respective information do not match, i.e., if the time of occurrence of the event is not the same as the time of capture of the image or if the geographic location of occurrence of the event is not the same as the geographic location of capture of the image. In some implementations, an event can be correlated with an image if a difference between a time of capture of the event and the time of occurrence of the event is within a threshold. In some implementations, if a difference between a geographic location of capture of the digital image and a geographic location of occurrence of the event is within a threshold, then the two can be correlated.

Alternatively, or in addition, a type of correlation between an image and an event can be based on the difference between the times corresponding to the image and the event, respectively. For example, it can be determined that the image was captured at a time different from a time of occurrence of the event. Based on the determination, text indicating that the event occurred at a time different from the time of capture of the digital image can be overlaid on the digital image during display. The text can be selected based on the time difference. To do so, a timeline that sequentially links all the times at which the device 130 captured digital images can be created. Events that occurred during the time between the capture of two successive images can be inferred. For example, events have a natural start and end time and various sub-events associated with the event. A sporting event has a start and end time, and the each change in score during the course of the sporting event represents a sub-event. The time of occurrence of each sub-event can be associated with a time of capture of an image on the timeline. Because the time of occurrence of a sub-event may not coincide with the time of capture of an image, correlations can be performed by interpolation to identify a state of a sub-event at a time of capture of a digital image.

Similar correlations can be created based on a difference between a geographic location of capture of the digital image and a geographic location of occurrence of the event. For example, a digital image can be associated with a geographic location on a time line, and the geographic location can be used to infer and/or correlate other information with the image. To determine if a user captured a digital image at the geographic location at which the event occurred, a distance from the geographic location of the event can be compared with that at which the image was captured. If the distance is within a threshold, then it can be determined that the digital image was captured at the location of occurrence of the event.

Events can also include acts performed by a user of the device 130 with the device 130. The device 130 can be configured to play digital audio in response to input from the user. For example, the playing of the audio represents an event during which the particular music that is played at a particular time instant is monitored. Monitoring can include identifying a time instant and storing a title of a song that was playing at the time instant. Monitoring can additionally include identifying and storing all or a portion of the song that was playing between two time instants.

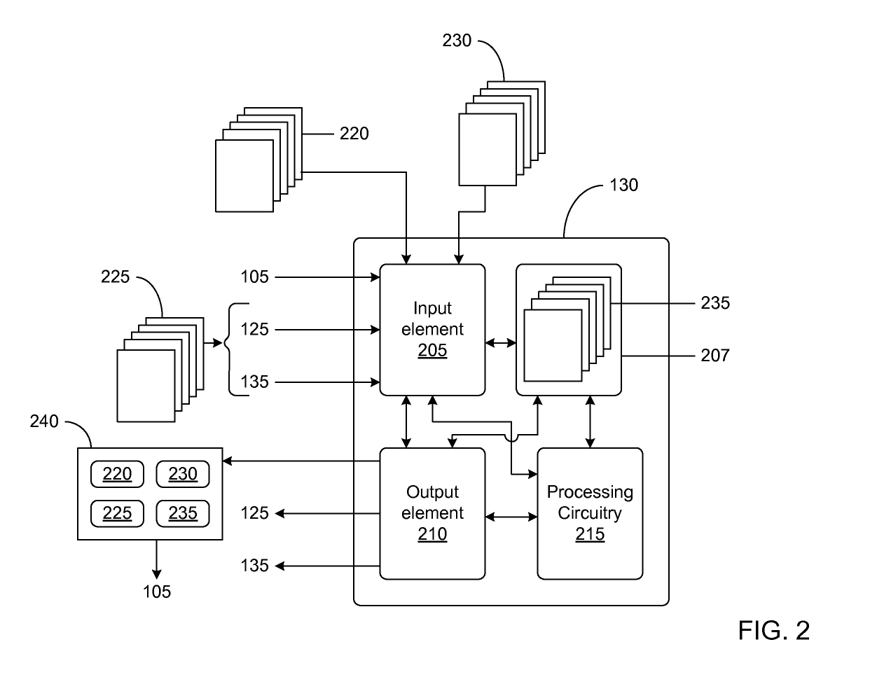

The device 130 can additionally be configured to allow a user to create electronic notes and include text in the notes. The creation of the note can represent an event. The information monitored during the event can include a time of creation of the note, the text entered by the user into the note, a geographic location at which the user created the note, and the like. The information obtained in the aforementioned manner, from both data hosts and users of the device 130, can be used to correlate monitored events and captured images using techniques described with reference to FIG. 2.

FIG. 2 shows an example mobile computing device 130 that exchanges information with multiple external devices. The device 130 includes an input element 205, an output element 210, and processing circuitry 215, operatively coupled to each other. The input element 205 is configured to receive input from one or more sources. The processing circuitry 215 is configured to execute computer software instructions to process the input received by the input element 205. The processing circuitry 215 is further configured to transmit the output of the execution to the output element 210, which, in turn, is configured to present the output. In addition, the device 130 includes a data storage 207 operatively coupled to the input element, the output element, and the processing circuitry 215. The data storage 207 stores the computer software instructions executable by the processing circuitry 215 to perform the operations to correlate digital media items and events.

In some implementations, the data storage 207 includes computer software instructions executable by the processing circuitry 215 to provide a user of the device 130 with a user interface in which the user can enter notes, i.e., text, which can be stored in the data storage 207. The input element 205 can receive the instruction to create a note, in response to which the processing circuitry 215 can transmit a note-taking user interface to the output element 210 for display to the user. The input element 205 can also receive the text that the user enters into the user interface. In response to input, the processing circuitry 215 can store the text in the data storage 207, retrieve the stored text, and transmit instructions to the output element to present the retrieved text.

In addition, the processing circuitry 215 is configured to track a time of creation of a note, which can be a time at which the input to create the note is received, a time at which text is entered into the note, a time at which the note is saved, and the like. The processing circuitry 215 is further configured to track times at which the user accesses the note and to edit the text in the note. The creation of the note is an event that can be correlated with a digital image captured using the device 130, as described below.

For example, within a duration before or after creating a note, the user captures a digital image using the device 130. The device 130 stores a time of creation of the note and a time of capture of the digital image. If the duration between the creation of the note and the capture of the digital image is within a threshold, for example, one of five minutes, ten minutes, one hour, one day, then the processing circuitry 215 correlates the note and the digital image. When the processing circuitry 215 receives input to present the digital image, the circuitry 215 can additionally provide the contents of the note for presenting with the image.

In some implementations, the device 130 can determine that the note was created at a geographic location. For example, the processing circuitry 215 is configured to determine GPS coordinates in which the device 130 is located. When the device 130 is in a geographic location, then the processing circuitry 130 associates any note created using the device 130 at the geographic location with images captured at the location.

In some implementations, the device 130 can be configured to present a calendar in which appointments can be created. The creation of an appointment is an event, and the time of creation of the appointment and details of the appointment are included in the digital information describing the event. For example, the processing circuitry 215 can be configured to present a calendar appointment user interface into which the user enters details about the appointment, for example, a time and a place, a person with whom the appointment is scheduled, and the like.

The information entered into the calendar appointment user interface can be used to correlate the appointment with digital images taken during or near the time of the appointment or those taken at a geographic location at or near the place of the appointment or both. Alternatively or in addition, the information entered into the calendar appointment can be used to correlate digital images captured at a present time with appointments that occurred in the past or to correlate an appointment created at a present time with digital images captured in the past.

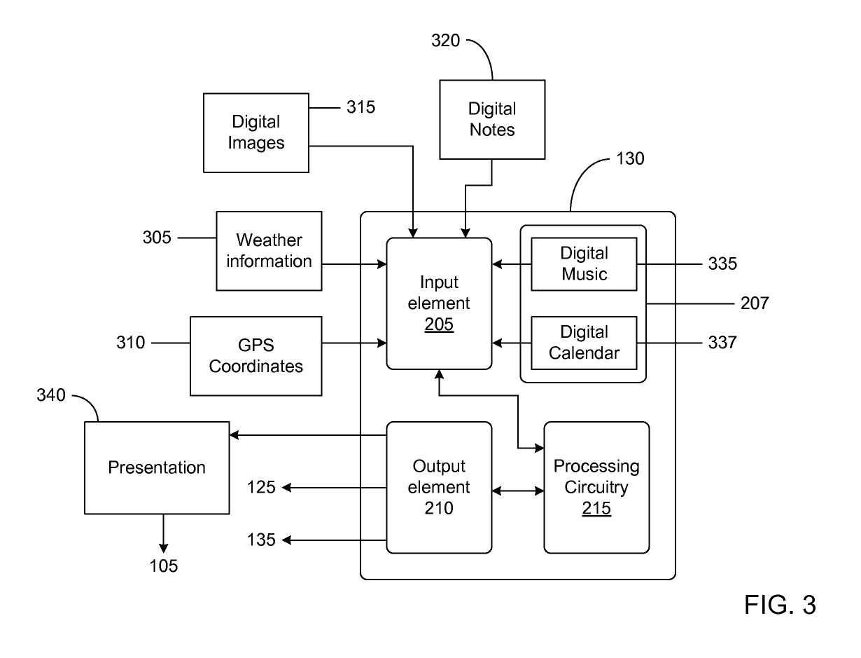

In this manner, the device 130 can receive information from various sources to correlate with digital images. In some implementations, the input element 205 can receive image information 220 from sources including a hard disk of the computer system 105, any other data storage device storing the digital images, and from digital images captured by the user using the device 130. The device 130 can receive digital information describing events from the data hosts 125 either directly or through the telephone service provider 135 or both. Additionally, the device 130 can receive digital information 230 from the events created by the user using the device 130. Further, the processing circuitry 215 can store in the data storage 207 information 235 that can include image information or digital information describing events or both, all of which have been previously transferred to the device 130. By executing the aforementioned techniques, the processing circuitry 125 can correlate the digital images and the events, and transmit the correlations through the output element 210, for example, to the computer system 105 for presenting as a presentation 240. An example of such a presentation is described with reference to FIG. 3.

FIG. 3 shows an example mobile computing device that creates a presentation of correlated digital images and events. The event is a social gathering in which multiple events occur. The device 130 is used to capture multiple digital images and the image information 315 associated with the digital images are received and stored in the data storage 207. Weather information 305 describing the weather during the social gathering is also received by the device 130 from the data hosts 125. The device 130 is further configured to track geographic locations and receives GPS coordinates 310. In addition, the device 130 receives digital notes information 320 from notes created using the device during the social gathering. The data storage 207 can include digital music from which digital music information 335 can be obtained. The data storage 207 can further include a digital calendar from which calendar information 337, for example, listing all persons who accepted an invitation to the social gathering. Using the aforementioned digital information, and additional digital information received from one or more other sources, the processing circuitry 215 can generate a presentation 340 including the digital images captured during the social gathering augmented with the digital events that occurred during the gathering.

Electronic notes represent one form of user created content that can be correlated with digital images. Other forms are also possible. For example, the user can use the device 130 to enter text on web pages of websites, such as Facebook, Twitter, and the like. The text entered on the web pages using the device 130 can be used to correlated with images. In one example, a user captures multiple digital images at a location, and then enters “This location is great.” on the web page. By automatically correlating the digital images and the text, an auto-caption is created which provides contextual information to the user when the images are subsequently viewed.

In some implementations, the device 130 can automatically generate the presentation 340 upon receiving the digital information. Automatic generation of the presentation 340 can include generating the presentation without additional input or intervention from a user after the image information and the digital information have been received. In some implementations, the presentation can include a slide show of all the digital images that a user of the computer system 105 captured using the device 130. Over the images in the slide show, digital information, including the ambient temperature at the geographic location of and at the time of the social gathering can be displayed. Further, music that was being played on the device 130 during the social gathering can be played in the background as the images in the presentation are being displayed.

In some situations, a user of the computer system 105 can receive images taken by other attendees at the social gathering. Image information associated with the received images can include times of capture of the received images. The computer system 105 can correlate the received images with the images and the digital information in the presentation received from the device 130, and create the presentation 425.

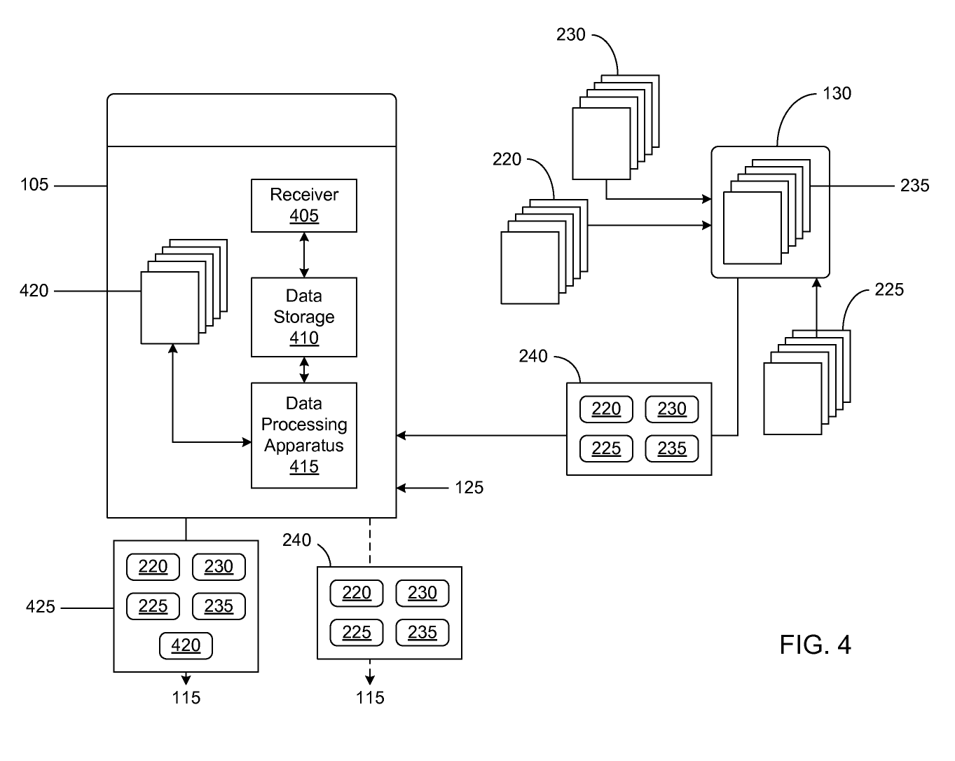

In some implementations, the device 130 can generate the presentation 340 in response to input from the user to generate an augmented presentation correlating images and events. The processing circuitry 215 can instruct the output element 210 to transmit the presentation 340 to the computer system 105. The computer system 105 can display the presentation 340 in the display device 110 or can further augment the presentation 340 prior to display, as described with reference to FIG. 4.

FIG. 4 shows an example computer system 105 that presents correlated digital images and events. As described previously, the mobile computing device 130 can create a presentation 240 that includes digital images and events using correlations between the image information and the digital information, and transmit the presentation 240. In some implementations, the device 130 can transmit the presentation 240 to the computer system 105. For example, the device 130 can be synchronized with the computer system 105 through wired or wireless networks 120, and can transfer the presentation 240 through the networks 120.

The computer system 105 includes a receiver 405 to receive the presentation 240 from the device 130, and a data storage 410 to receive the presentation. The computer system 105 further includes a data processing apparatus 415 configured to transmit the presentation 240 to the display device 110 to display the presentation 240.

In some implementations, the computer system 105 can use digital information 420, stored, for example, on the data storage 410, to create additional correlations between the digital images and the events received by the device 130. To do so, the computer system 105 can receive the digital images and the events from the device 130. With the digital images and the events, the computer system 105 can receive the image information and the digital information using which the device 130 developed the correlations and created the presentation 240. The computer system 105 can store all the received information in the data storage 410.

Using techniques similar to those described with reference to the device 130, the computer system 105 can use the digital information 420 to develop correlations and create a new presentation 425 for displaying in the display device 115. Specifically, for example, the computer system 105 can create the correlations using digital images and digital information obtained by the computer system 105 using sources different from the device 130.

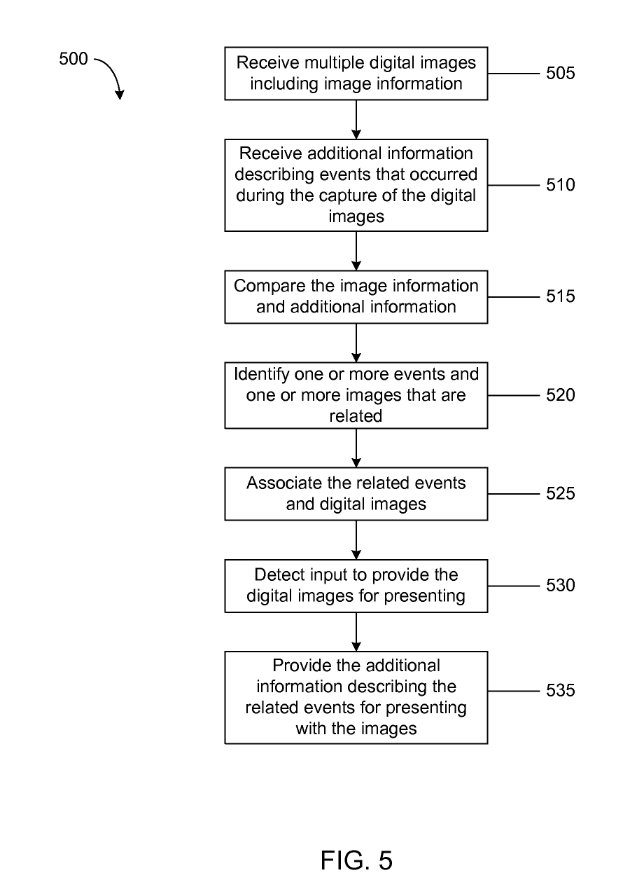

FIG. 5 is a flow chart of an example process 500 for correlating digital images and events. The process 500 receives multiple digital images including image information at 505. The process 505 receives additional information describing events that occurred during the capture of the digital images at 510. The process 500 compares the image information and additional information at 515. The process 500 identifies one or more events and one or more images that are related at 520. The process 500 associates the related events and digital images at 525. The process 500 detects input to provide the digital images for presenting at 530. The process 500 provides the additional information describing the related events for presenting with the images at 535.

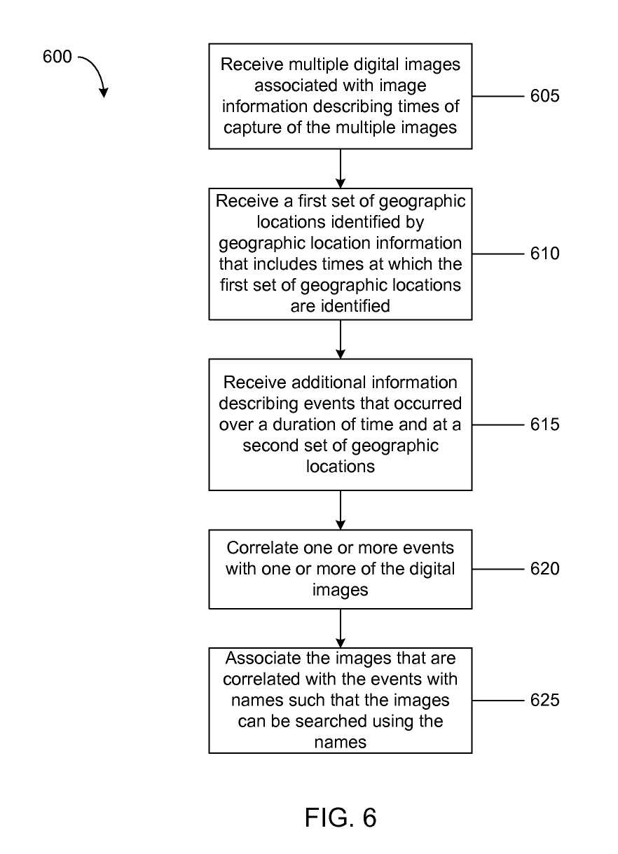

FIG. 6 is a flow chart of an example process 600 for storing correlated digital images and events under a name. The process 600 receives multiple digital images associated with image information describing times of capture of the multiple images at 605. The process 600 receives a first set of geographic locations identified by geographic location information that includes times at which the first set of geographic locations are identified at 610. The process 600 receives additional information describing events that occurred over a duration of time and at a second set of geographic locations at 615. The process 600 correlates one or more events with one or more of the digital images at 620. The process 600 associates the images that are correlated with the events with names such that the images can be searched using the names at 625.

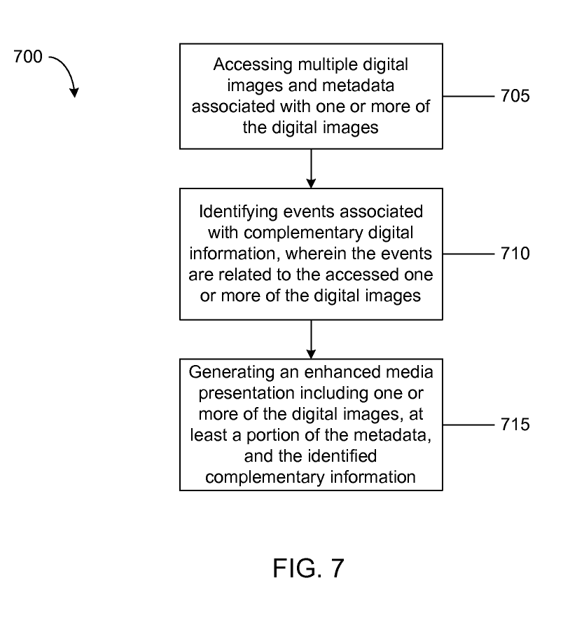

FIG. 7 is a flow chart of an example process 600 for generating an enhanced media presentation. 27. The process 700 accesses multiple digital images and metadata associated with one or more of the digital images at 705. The process 700 identifies events associated with complementary digital information at 710. The events are related to the accessed one or more digital images. The process 700 generates an enhanced media presentation including one or more of the digital images, at least a portion of the metadata, and the identified complementary information at 715.

To generate the enhanced media presentation, the process 700 can detect input to include the digital image correlated with the event in the enhanced media presentation, automatically include the event in the enhanced media presentation, and present the event concurrently with the digital image. When the process 700 automatically includes the event in the enhanced media presentation, the process 700 does so in the absence of input or other forms of intervention from a user or any other device.

Each of the process 500, the process 600, and the process 700 is executable either by the computer system 105 or the mobile computing device 130 or both. The computing system 105 can receive input from input devices 115, for example, a keyboard, a mouse, a stylus, and the like. The computing system 105 is operatively coupled to multiple devices through one or more wired or wireless networks 105, for example, the Internet, Wi-Fi, Local Area Network (LAN), Wide Area Network (WAN), and the like. Both the computing system 110 and the mobile computing device 130 can transfer digital media items between each other through the network 120. For example, the computing system 105 and the mobile computing device 130 are coupled and can exchange data through a Wi-Fi network.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. The computer storage medium can also be, or be included in, one or more separate physical components or media (for example, multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (for example, one or more scripts stored in a markup language document), in a single file dedicated to the program in question, or in multiple coordinated files (for example, files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and an apparatus can also be implemented as, special purpose logic circuitry, for example, an FPGA (field programmable gate array) or an ASIC (application specific integrated circuit).

The processes and logic flows can further be implemented by one system of one or more computers to execute another system of one or more computers over one or more wired or wireless networks, such as the Internet. For example, the processes and logic flows can be encoded as one or more computer programs on computer-readable media, which are executed by the other system to perform the processes.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, for example, magnetic, magneto optical disks, or optical disks. However, a computer need not have such devices.

Devices suitable for storing computer program instructions and data include all forms of non volatile memory, media and memory devices, including by way of example semiconductor memory devices, for example, EPROM, EEPROM, and flash memory devices; magnetic disks, for example, internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, for example, a CRT (cathode ray tube) or LCD (liquid crystal display) monitor, for displaying information to the user and a keyboard and a pointing device, for example, a mouse or a trackball, by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's computing device in response to requests received from the web browser.

Embodiments of the subject matter described in this specification can be implemented in a computing system that includes a back end component, for example, as a data server, or that includes a middleware component, for example, an application server, or that includes a front end component, for example, a client computer having a graphical user interface or a Web browser through which a user can interact with an implementation of the subject matter described in this specification, or any combination of one or more such back end, middleware, or front end components. The components of the system can be interconnected by any form or medium of digital data communication, for example, a communication network. Examples of communication networks include a local area network (“LAN”) and a wide area network (“WAN”), an inter-network (for example, the Internet), and peer-to-peer networks (for example, ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (for example, an HTML page) to a computing device (for example, for purposes of displaying data and receiving user input from a user interacting with the computing device). Data generated at the computing device (for example, a result of the user interaction) can be received from the computing device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. In some implementations, digital information describing a geographic location of occurrence of an event can be obtained from a digital address book stored on the device 130 or the computer system 105 or both, that includes addresses.

In some implementations, upon developing a correlation between digital images and events, the device 130 or the computer system 105 can identify key words or key phrases or both to represent the correlated images and events. The key words can be obtained from text received from a user, for example, in the notes, as entry in appointments, as data file names, as image captions, or combinations of them. In some implementations, the key words can be automatically generated. For example, based on a comparing of image information and digital information, it is determined that the images were captured at an event, the name of which is obtained from sources other than the user, for example, from the data hosts 125. In this example, the device 130 or the computer system 105 groups the images under the name of the event obtained from the data hosts 125. In response to receiving the name of the event from the user as a search query, the grouped images are retrieved and displayed in the display device.

What is claimed is:

1. A computer-implemented method for presenting digital media content, the method comprising:
receiving, by data processing apparatus, a plurality of digital images, a digital image being associated with image information that includes either a time of capture of the digital image or a geographic location of capture of the digital image or both;
receiving, by the data processing apparatus, additional information describing events that occurred either during times of capture or at or substantially near geographic locations of capture of one or more of the plurality of digital images;
comparing, by the data processing apparatus, the image information and the additional information to identify one or more events and one or more digital images that are related;
associating, by the data processing apparatus, the identified one or more events and the identified one or more digital images;
detecting, by the data processing apparatus, input to provide the plurality of digital images for presenting; and
providing, by the data processing apparatus, the additional information describing the identified one or more events for presenting with the identified one or more digital images.

2. The method of claim 1, wherein the additional information describing events is obtained by:
monitoring the events for a duration of time; and
collecting the additional information at particular instances during the duration.

3. The method of claim 2, wherein the additional information describing events is further obtained by:
monitoring geographic locations at which the events occurred during the duration; and
collecting geographic location information at the geographic locations at which the events occurred during the duration, wherein the geographic locations information includes, for a geographic location, a time at which the events occurred at the geographic location.

4. The method of claim 1, wherein comparing the image information and the additional information comprises:
storing a plurality of events scheduled to occur at future times in a database;
comparing a time of capture of a digital image with times of occurrences of the plurality of events to identify the one or more events.

5. The method of claim 4, wherein associating an event with the plurality of digital images based on the comparing comprises determining that a time of occurrence of the event was substantially near a time of capture of a digital image in the plurality of digital images.

6. The method of claim 1, wherein geographic information, included in the image information, describes the geographic location of capture, the method further comprising:
receiving a digital image associated with geographic information;
searching a database of geographic locations to identify the geographic location described by the geographic information; and
associating the geographic location with the digital image.

7. The method of claim 1, wherein the additional information includes ambient temperatures at a geographic location obtained by monitoring weather at the geographic location for a duration, the method further comprising:
determining, based on the comparing, that a digital image of the plurality of digital images is captured at the geographic location at which the weather is monitored;
associating the ambient temperature collected at the time of capture of the digital image with the plurality of digital images; and
upon detecting an input to provide the plurality of digital images, automatically providing the collected ambient temperature with the plurality of digital images.

8. The method of claim 1, wherein the image information includes metadata associated with each digital image.

9. The method of claim 8, further comprising associating the metadata with each digital image subsequent to the time of capture.

10. The method of claim 1, wherein capturing the plurality of digital images, the receiving of the image information, and the receiving of the additional information are performed by a mobile communication device further configured to perform the comparing, the associating, the detecting, and the providing.

11. A computer-readable medium, tangibly encoding software instructions, executable by data processing apparatus to perform operations comprising:
receiving a plurality of digital images associated with image information describing times of capture of the plurality of digital images;
receiving a first plurality of geographic locations identified by geographic location information that includes times at which the first plurality of geographic locations are identified;
receiving additional information describing events that occurred over a duration of time and at a second plurality of geographic locations, wherein the additional information is received after receiving the plurality of digital images and the first plurality of geographic locations;
correlating one or more events with one or more of the digital images based on determining that one or more of the digital images were captured during the duration that one or more events occurred or substantially near one or more of the second plurality of geographic locations at which the one or more events occurred; and
associating the one or more digital images that are correlated with the one or more events with names of the one or more correlated event such that in response to a search query that includes a name of one of the correlated events, the one or more digital images are provided as search results.

12. The medium of claim 11, the operations further comprising:
receiving the search query that includes a name of one of the correlated events; and
in response to the receiving, providing the grouped one or more digital images.

13. The medium of claim 12, wherein providing the grouped one or more digital images comprises:
presenting the grouped one or more digital images; and
presenting, with the presented digital images, digital content representing the one or more correlated events with which the presented digital images are correlated.

14. The medium of claim 11, wherein receiving the additional information describing the events further comprises receiving the additional information from one or more external devices configured to monitor the events, to periodically record times of occurrences of the events, and to record the geographic locations in which the events occur.

15. The medium of claim 11, wherein the plurality of digital images are received from a mobile communication device configured to capture digital images, the image information represented by metadata associated with each of the digital images, the metadata including a time of capture of a digital image.

16. The medium of claim 15, wherein the geographic location information is received from the mobile communication device configured to track Global Positioning System (GPS) coordinates at which the mobile communication device is located.

17. The medium of claim 16, wherein the additional information is received from a calendar software application executing on the mobile communication device, the calendar software application storing a plurality of appointments, each appointment representing an event spanning a duration of time,
wherein a digital image is correlated with an appointment upon determining that the time of capture of the digital image is within the duration of the appointment, and
wherein the digital image is associated with text included in the appointment, the text identifying the appointment.

18. An apparatus including:
an input element;
an output element; and
processing circuitry operatively coupled to the input element and the output element to perform operations comprising:
receiving a plurality of digital images, a digital image being associated with image information that includes either a time of capture of the digital image or a geographic location of capture of the digital image or both;
receiving additional information describing events that occurred either during times of capture or at or substantially near geographic locations of capture of one or more of the plurality of digital images;
comparing the image information and the additional information to identify one or more events and one or more digital images that are related;
associating the identified one or more events and the identified one or more digital images;
detecting input to provide the plurality of digital images for presenting; and
providing the additional information describing the identified one or more events for presenting with the identified one or more digital images.

19. The apparatus of claim 18, the operations further comprising:
capturing the plurality of digital images; and
associating a time of capture with each of the captured digital images.

20. The apparatus of claim 18, the operations further comprising tracking geographic locations at which the input element and the output element are located, the tracking including periodically recording times at which the input element and the output element are at the geographic locations.

21. The apparatus of claim 18, wherein the additional information describing the events is received from an external device configured to monitor the events and to associate the additional information with the events based on the monitoring.

22. The apparatus of claim 18, wherein the input element is configured to receive digital content, the output element is configured to present the received digital content, the processing circuitry is configured to include in the additional information, a time at which the received digital content is provided, the operations further comprising:
comparing times of capture of digital images and the time at which the digital content is provided;
correlating one or more digital images with the provided digital content upon determining that the time at which the digital content was provided was within a threshold of the time at which the one or more digital images were captured; and
providing the digital content for presenting with the correlated one or more digital images.

23. The apparatus of claim 22, wherein the received digital content is a digital song, the processing circuitry configured to play the digital song, to monitor a time at which the digital song is played, and to include the time of playing the digital song in the additional information, and
wherein providing the digital content for presenting with the correlated one or more digital images comprises including the digital song with the correlated one or more digital images, such that when the correlated one or more digital images are displayed, at least a portion of the digital song is simultaneously played.

24. A method comprising:
accessing, by data processing apparatus, a plurality of digital images and metadata associated with one or more of the digital images;
identifying, by the data processing apparatus, events associated with complementary digital information, wherein the events are related to the accessed one or more of the digital images, and
generating, by the data processing apparatus, an enhanced media presentation comprising one or more of the digital images, at least a portion of the metadata, and the identified complementary information.

25. The method of claim 24, further comprising correlating the events with the one or more of the digital images by comparing the metadata associated with the one or more of the digital images and the complementary digital information associated with the events.

26. The method of claim 25, wherein the digital information associated with an event includes a time of occurrence of the event, wherein the metadata associated with a digital image includes a time of capture of the digital image, and wherein correlating the events with the one or more of the digital images includes:
determining a difference between the time of occurrence of the event and the time of capture of the digital image; and
upon determining that the difference is within a threshold, correlating the event and the digital image.

27. The method of claim 26, wherein generating the enhanced media presentation includes:
detecting input to include the digital image correlated with the event in the enhanced media presentation;
automatically including the event in the enhanced media presentation; and
presenting the event concurrently with the digital image.
